(19) United States
(12) Patent Application Publication
(10) Pub. No.: US 2010/0094663 A1
(43) Pub. Date: Apr. 15, 2010

(54) HEALTH PLAN ENROLLMENT SYSTEMS AND METHODS OF USE THEREOF

(76) Inventor: Jamie Spriggs, Baltimore, MD (US)

Correspondence Address: BRYAN CAVE LLP, 211 NORTH BROADWAY, SUITE 3600, ST. LOUIS, MO, 63102-2750, US

(21) Appl. No.: 12/504,324

(22) Filed: Jul. 16, 2009

Related U.S. Application Data
(63) Continuation-in-part of application No. 12/325,368, filed on Dec. 1, 2008, now abandoned.
(60) Provisional application No. 61/005,073, filed on Nov. 30, 2007.

(51) Int. Cl. G06Q 40/00; G06Q 10/00

(52) U.S. Cl. 705/4; 705/322

(57) ABSTRACT

The present invention relates to certain on-line health and benefits plan enrollment systems and methods of use thereof. According to certain embodiments of the present invention, systems are provided for enrolling employees in, and administering, one or more employee health plans. Such embodiments generally comprise at least one server that is capable of hosting a website that may be accessed by an employer via the internet. The website preferably comprises an employer enrollment portal that allows an employer to establish itself as the health care plan administrator. The employer enrollment portal is preferably capable of submitting various types of information to the server, such as the name and address of the employer, payroll information, employer bank information, health plan co-pay amounts, required employee contribution amounts and frequency, enrollment data, or any combination of the foregoing. The website preferably further comprises an employer plan management portal that allows the employer to manage and modify the employee health plan. Still further, the website preferably comprises an employee plan management portal that allows employees to manage and modify their health plans.

### CROSS-REFERENCE TO RELATED APPLICATIONS

This application is a continuation-in-part of U.S. patent application Ser. No. 12/325,368, filed Dec. 1, 2008, which claims priority to U.S. provisional patent application No. 61/005,073, filed Nov. 30, 2007.

### p FIELD OF THE INVENTION

The field of the present invention relates to on-line health and benefits plan enrollment systems and methods of use thereof.

### BACKGROUND OF THE INVENTION

Employer health and benefit plan enrollment processes are utilized by most businesses to offer employees the ability to apply for, enroll and participate in a health plan. Non-limiting examples of such health plans include flexible spending accounts (FSAs), health reimbursement arrangements (HRAs), health savings accounts (HSAs), and others.

In many cases, enrolling employees in these types of health plans can be labor intensive and confusing to employees, particularly when the enrollment process involves paper forms and manual processing. Even for those systems that are currently-available via the internet (and/or employer intranets), the different components that make up the system are often poorly integrated. For example, a health plan enrollment system may include, among other things, (i) a component that allows employers to register with a particular health plan, such that its employees may enroll and participate in the same, (ii) a component that allows employees to access and enroll in a desired health plan, (iii) a component that allows enrolled employees to participate in, manage, and make adjustments to one or more health plans, (iv) a component that allows employers to manage and make adjustments to their accounts, and others.

In many cases, existing on-line health plan enrollment systems poorly integrate the foregoing components (and others). As such, a demand exists for improved on-line health and benefits plan enrollment systems and methods of use thereof.

### SUMMARY OF THE INVENTION

According to certain embodiments of the present invention, systems are provided for enrolling employees in, and administering, one or more employee health plans. Such embodiments generally comprise at least one server that is capable of hosting a website that may be accessed by an employer via the internet. The server will preferably comprise a central processing unit that is capable of executing one or more computer programs. The website preferably comprises an employer enrollment portal that is capable of communicating with the central processing unit, which allows an employer to establish itself as the health care plan administrator for one or more health care plans. The employer enrollment portal is preferably designed to allow an employer to submit various types of information to the central processing unit within the server, such as the name and address of the employer, payroll information, employer bank information, health plan co-pay amounts, required employee contribution amounts and frequency, enrollment data, or any combination of the foregoing, which are used to establish one or more health care plans for a plurality of employees. The website preferably further comprises an employer plan management portal, through which the employer may submit instructions to the central processing unit for the purpose of managing and modifying its employee health plan. Still further, the website preferably includes an employee plan management portal, through which the employees may submit instructions to the central processing unit for the purpose of managing and modifying their employee health plans.

According to certain additional embodiments of the present invention, methods for enrolling employees in one or more health plans are provided. Such embodiments generally comprise (a) providing employees with the ability to access an employee enrollment portal within a website that is hosted within one or more servers, (b) enabling the employees to submit instructions to the central processing unit within the one or more servers, which allows the employees to register a health care plan account using the employee enrollment portal, and (c) creating and distributing employee membership (or healthcare payment) cards to enrolled employees. The employee membership cards may be distributed by the employer, a third party administrator, or by the employer and a third party administrator, and may be used by employees to make purchases toward healthcare expenses.

The above-mentioned and additional features of the present invention are further illustrated in the Detailed Description contained herein.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used, and made without departing from the scope and spirit of the invention.

According to certain embodiments of the present invention, systems are provided for enrolling employees in, and administering, one or more employee health care plans. Non-limiting examples of such health care plans include flexible spending accounts (FSAs), health reimbursement arrangements (HRAs), health savings accounts (HSAs), and others. As used herein, “health reimbursement arrangements” generally refers to a tax-favored savings account employees may use to pay for healthcare expenses. It is generally employer-funded and may allow employees to accumulate savings for future medical needs. HRAs may often be coupled with a standard or high deductible health plan (HDHP), or offered on its own. As used herein, “flexible spending accounts” generally refers to an employee benefit that allows employees to have pre-tax dollars withheld from their paycheck, which amounts may be used to pay for un-reimbursed health care or dependent care expenses. As used herein, “health savings accounts” generally refers to a tax-favored savings account that employees may use to pay for health care expenses. It is generally owned by the employee, is typically 100% vested, and allows an employee to accumulate savings for future needs.

While reference is made throughout this specification to health care plans, it should be appreciated that the systems and methods described herein may be used to enroll employees in, and administer, not only FSAs, HRAs, HSAs, or health care plans generally, but also other types of employee benefits plans. Non-limiting examples of other types of benefits plans may include life insurance policies, 401(k) plans, stock purchase programs, stock option programs, and others.

The systems of the present invention generally comprise at least one server that is capable of hosting a website that may be accessed by an employer via an internet connection. The website preferably comprises an employer enrollment portal that allows an employer to establish itself as the health care plan administrator. In certain embodiments, the employer will be required to “login” into the employer enrollment portal, by submitting an authentic and unique user name and password to a central processing unit housed within the server, which will determine whether such user name and password match those listed in a database of authorized users of the website. Upon submitting a valid username/password combination, the website may exhibit a web page in which an employer may verify that it is establishing itself as a health plan administrator for certain specified types of health care plans.

After successfully logging into the employer enrollment portal, the portal (website) is preferably capable of allowing the employer to submit various types of information to the central processing unit housed within the server. Non-limiting examples of such information may include the name and address of the employer, payroll information, employer bank information, health plan co-pay amounts, required employee contribution amounts and frequency, enrollment data, or any combination of the foregoing. Upon submitting such information to the central processing unit, the information will be stored in a series of fields within a database, such that the information for any particular employer may be quickly recalled and utilized by the server. The website preferably further comprises an employer plan management portal that allows the employer to submit instructions to the central processing unit to manage and modify the employee health plan.

More specifically, for example, upon successfully establishing an administrator login, the website will preferably provide the employer-user with the option to continue registering a health care plan for its employees. The invention provides that an employer may continue to register a health care plan for its employees or, alternatively, leave the website and conduct the registration at a later time (by, for example, entering the website using its assigned user name and password).

Once the employer decides to continue registering a health care plan for its employees, the employer will preferably be required to identify, among other things, the effective date of the subject health care plan and information related to its payroll systems—by submitting such information to the central processing unit described herein, such that the effective date may then be recorded in a database in communication with the central processing unit. In addition, the invention provides that the employer will preferably provide the central processing unit, vis-à-vis a secure and preferably encrypted connection to the website described herein, with certain information related to its bank account, such as account numbers, routing numbers, SWIFT codes, and the like. The invention provides that bank account information may be necessary to enable, and automate, payments to insurance carriers, health care providers, employees, and/or other persons.

Still further, in certain preferred embodiments, the employer enrollment portal will preferably allow the employer to submit instructions to the central processing unit, which designates health plan co-pay amounts for a plurality of health care providers, pharmaceutical types, or a combination thereof. For example, the employer enrollment portal will preferably allow employers to specify, by submitting one or more instructions to the central processing unit, the desired co-pay amount for primary care physicians, specialists, inpatient hospital care givers, emergency room services, well child services, outpatient surgery visits, or a combination thereof. In addition, for example, the employer enrollment portal will preferably allow employers to submit instructions to the central processing unit in order to specify the desired co-pay amount for generic pharmacy, formulary brands, combinations thereof, as well as co-pay amounts for pharmaceutical prescriptions over defined periods of time, such as 30 days, 90 days, and so on. According to certain preferred embodiments, the employer enrollment portal will preferably allow the employer to further designate, by submitting appropriate instructions to the central processing unit, its health care plan contribution amounts and frequency. The phrase “submitting appropriate instructions to the central processing unit,” and similar phrases used herein, refers to the act of providing the central processing unit with information, data, or other commands, which may be provided vis-à-vis an on-line form that is accessible within the website described herein, which, upon receipt by the central processing unit, is (1) stored within the appropriate field (or table) of a database, (2) further modified or processed and then stored within the appropriate field (or table) of a database, (3) processed and used to present the user with subsequent options and data fields within which to submit information to the central processing unit, or (4) any combination of the foregoing.

A further aspect of the systems described herein relates to the ability of the employer enrollment portal to transmit information—to the central processing unit—regarding the employees of the employer who wish to enroll in one or more health plans. For example, the employer enrollment portal will preferably allow an employer to submit its employee enrollment data to the central processing unit housed within the server by (a) manually entering and submitting the data within the website or (b) uploading a data file to the server within the website. The data file may, for example, consist of a spreadsheet, such as a Microsoft Excel® spreadsheet. In the event that the employer desires to upload a spreadsheet to the server, the invention provides that, preferably, the server will be capable of publishing a web page that summarizes the employee enrollment data that has been successfully provided to the server. Still further, in certain preferred embodiments, the server may comprise a script that is capable of reviewing employee enrollment data (submitted by the employer to the central processing unit) for errors. In the event that errors are detected, the invention provides that a web page may, preferably, be published which identifies such errors and provides the employer-user with the ability to correct such errors.

As described above, the employer enrollment portal will also, preferably, allow an employer to submit to the central processing unit, its employee enrollment data by manually entering and submitting the data through the website. Similar to the other embodiments described herein, the employer enrollment portal will preferably be capable of displaying, perhaps in a separate web page, the employee enrollment data that have been successfully submitted to the server via the website described herein. It should be recognized by those of ordinary skill in the art that the number, and identity, of employees (of a particular employer) is dynamic and will change over time. Accordingly, the invention provides that the employer enrollment portal will also, preferably, allow an employer to submit to the central processing unit new employee enrollment data to the server over time, even after its health care plan has been established and registered with the server.

The employer enrollment portal will also, preferably, allow an employer to specify a health plan contribution amount for each employee, by submitting instructions to the central processing unit to specify and record such amounts in the appropriate field of the database described herein. For example, the employer enrollment portal may allow an employer to submit to the central processing unit an instruction which specifies an amount that each employee must pay (or contribute to) in order to benefit from one or more health plans. In such embodiments, the employer will preferably be able to make such contribution designations for each health plan in which each employee has elected to participate. The contribution amount designated for each employee, and for each type of health plan, will preferably be presented in a summary page, which enables the employer to verify such information for accuracy before submission to the server and central processing unit. Upon submitting all necessary information to the central processing unit, by entering and/or uploading such information and employee enrollment data within the website described herein, the employer enrollment portal may allow the employer to indicate that all information and data has been entered and that the corresponding health plans should be established. The invention provides that, in certain embodiments, an e-mail may be delivered to the employer (and issued by the server described herein), which confirms that it has successfully registered its health plans and enrolled its employees. Similarly, in certain embodiments, an e-mail may be delivered to each employee, which confirms that his or her employer has successfully registered him or her for the desired health plan(s).

According to certain preferred embodiments, the system further comprises an employer plan management portal. For example, the employer plan management portal will allow an employer to submit instructions to the central processing unit, to manage and modify the employee health plan attributes that it previously designated for its health care plans and employees. For example, such attributes may include, but are not limited to, system authorization information, employee plan contributions, employer plan contributions, employer identity information, employer bank account information, the identity and number of enrolled employees, the identity of canceled and/or terminated employees, or any combination of the foregoing. In certain preferred embodiments, the employer plan management portal will further allow an employer to generate reports related to its health plans and enrolled employees. These reports may summarize, for example, participant accounts, weekly claims details, claims requiring further documentation, rejected claims, paid claims, or any combination thereof.

After the employer has successfully registered the applicable health plans, and enrolled it employees therein, the invention provides that employee membership cards may be distributed to each employee. The employee membership cards will preferably contain information, or other identifiers (including magnetically scanned identifiers or numeric identifiers), which identify the applicable employee, the health care plan(s) in which the particular employee participates, and/or other relevant information. In certain embodiments, the employee membership card may be used by enrolled employees to make payments towards healthcare expenses. In such embodiments, the identifier shown and/or retrievable from each card will be correlated with an employee and his/her health care plan(s) within a database, which may be housed or in communication with the central processing unit described herein.

Still further, in certain embodiments, the website described herein may further comprise an employee plan management portal. The employee plan management portal will, preferably, be accessed by each enrolled employee (using an authentic and unique username and/or password) to access his or her health plan account. The employee plan management portal will, preferably, allow each employee to submit information and commands to the central processing unit described herein, to manage and modify various attributes of his or her health plan(s).

According to certain additional embodiments of the present invention, methods for enrolling employees in one or more health plans are provided, which utilize the systems described herein. Such embodiments generally comprise (a) accessing an employer enrollment portal within a website that is hosted within one or more servers, (b) registering a health care plan account using the employer enrollment portal by submitting information to a central processing unit housed within the one or more servers, wherein registering a health care plan account will make one or more health care plans available to a plurality of employees, (c) distributing materials related to the one or more health care plans to a group of employees, (d) holding an open enrollment session during which employees elect whether to participate in the one or more health care plans, and (e) distributing employee membership cards to enrolled employees, wherein distribution of the employee membership cards may be performed by the employer, a third party administrator, and a combination thereof. The invention provides that the healthcare payments cards may be distributed by the employer, a third party administrator, or by the employer and a third party administrator.

Although illustrative embodiments of the present invention have been described herein, it should be understood that the invention is not limited to those described, and that various other changes or modifications may be made by one skilled in the art without departing from the scope or spirit of the invention.

What is claimed is:

1. A system for enrolling in and administering employee health plans, which comprises at least one server and at least one central processing unit, which are capable of hosting a website that may be accessed by an employer and a plurality of employees via an internet connection, wherein the website comprises:
(a) an employer enrollment portal that allows the employer to submit information to the central processing unit and to establish the employer as an employee health plan administrator, wherein the employer enrollment portal further enables the employer to submit information to the central processing unit that is necessary to establish one or more employee health plans;
(b) an employer plan management portal that allows the employer to submit information to the central processing unit to manage and modify the one or more employee health plans; and
(c) an employee plan management portal that allows an employee to submit information to the central processing unit to manage and modify his or her health plan.

2. The system of claim 1, wherein the information submitted to establish one or more employee health plans is selected from the group consisting of a name and address of the employer, payroll information, employer bank information, health plan co-pay amounts, required employee contribution amounts and frequency, enrollment data, and any combination of the foregoing.

3. The system of claim 2, wherein the health plan co-pay amounts are submitted to the central processing unit and are correlated within a database to a plurality of healthcare providers, pharmaceutical types, or a combination thereof.

4. The system of claim 3, wherein:
(a) the healthcare providers comprise primary care physicians, specialists, inpatient hospital care givers, emergency room services, well child services, outpatient surgery visits, or a combination thereof; and
(b) the pharmaceutical types comprise generic pharmacy, formulary brands, or a combination thereof.

5. The system of claim 4, wherein the enrollment data may be submitted to the central processing unit by (a) manually entering and submitting the data to the central processing within the website or (b) uploading a data file to the central processing unit within the website.

6. The system of claim 5, wherein the data file is a spreadsheet.

7. The system of claim 6, wherein the server and central processing unit are capable of publishing a web page that lists the uploaded enrollment data.

8. The system of claim 7, wherein enrollment data for additional employees may be submitted to the central processing unit within a dedicated web page after the employer has established the one or more employee health plans.

9. The system of claim 8, which further comprises a web page that is accessible within the employer enrollment portal that enables the employer to submit an instruction to the central processing unit which specifies the required employee contribution amounts.

10. The system of claim 9, wherein the required employee contribution amounts will be paid by the employer, employee, or a combination thereof.

11. The system of claim 2, further comprising a script housed within the server that will review information and data submitted by the employer for errors.

12. The system of claim 1, wherein the employer plan management portal allows an employer to submit instructions to the central processing unit to manage and modify employee health plan attributes, wherein the attributes are selected from the group consisting of system authorization information, employee plan contributions, employer plan contributions, employer identity information, employer bank account information, enrolled employees, canceled or terminated employees, and any combination of the foregoing.

13. The system of claim 12, wherein the employer plan management portal further allows an employer to submit instructions to the central processing unit to generate plan reports that summarize participant accounts, weekly claims details, claims requiring further documentation, rejected claims, paid claims, or any combination thereof.

14. The system of claim 1, which further comprises employee membership cards, which comprise magnetic or numeric identifiers, wherein each magnetic or numeric identifier is correlated with a single employee, wherein the employee membership cards may be used by employees to make payments towards healthcare expenses.

15. A method for enrolling employees in one or more health plans, which comprises:
(a) accessing an employer enrollment portal within a website that is hosted within one or more servers;
(b) registering a health care plan account using the employer enrollment portal by submitting information to a central processing unit housed within the one or more servers, wherein registering a health care plan account will make one or more health care plans available to a plurality of employees;
(c) distributing materials related to the one or more health care plans to a group of employees;
(d) holding an open enrollment session during which employees elect whether to participate in the one or more health care plans; and
(e) distributing employee membership cards to enrolled employees, wherein distribution of the employee membership cards may be performed by the employer, a third party administrator, and a combination thereof.

16. The method of claim 15, wherein the employer enrollment portal enables the employer to submit to the central processing unit information that is necessary to establish the one or more health care plans.

17. The method of claim 16, wherein the information that is necessary to establish the one or more health care plans is selected from the group consisting of a name and address of the employer, payroll information, employer bank information, health plan co-pay amounts, required employee contribution amount and frequency, enrollment data, and any combination of the foregoing.

18. The method of claim 17, which further comprises submitting the health plan co-pay amounts for a plurality of healthcare providers, pharmaceutical types, or a combination thereof.

19. The method of claim 18, wherein:
(a) the healthcare providers comprise primary care physicians, specialists, inpatient hospital care givers, emergency room services, well child services, outpatient surgery visits, or a combination thereof; and
(b) the pharmaceutical types comprise generic pharmacy, formulary brands, or a combination thereof.

20. The method of claim 19, which further comprises submitting the enrollment data to the central processing unit by (a) manually entering and submitting the data within the website or (b) uploading a data file to the server within the website.
